(19) United States
(12) Patent Application Publication
(10) Pub. No.: US 2007/0270994 A1
(43) Pub. Date: Nov. 22, 2007

(54) SYSTEM AND METHOD FOR GENERATING A YIELD MODEL FOR AN INTEGRATED CIRCUIT FABRICATION PROCESS AND METHOD OF MANUFACTURING AN INTEGRATED CIRCUIT USING THE YIELD MODEL

(75) Inventors: Joel Lynn Dobson, Rowlett, TX (US); William Todd Dyer, Garland, TX (US)

Correspondence Address: TEXAS INSTRUMENTS INCORPORATED, P O BOX 655474, M/S 3999, DALLAS, TX, 75265, US

(73) Assignee: Texas Instruments, Incorporated, Dallas, TX (US)

(21) Appl. No.: 11/419,310

(22) Filed: May 19, 2006

(51) Int. Cl. G06F 19/00

(52) U.S. Cl. 700/121; 716/4; 700/97

(57) ABSTRACT

A system for, and method of, generating a yield model pertaining to an integrated circuit (IC) fabrication process and a method of manufacturing an IC using the yield model. In one embodiment, the method of generating includes: (1) selecting X-variables as candidates for incorporation into the yield model, (2) sorting the candidates into an order based on a ranking criterion and (3) introducing the candidates in the order into a stepwise forward regression model until a marginal significance associated with a candidate to be introduced into the model falls below a threshold.

### TECHNICAL FIELD OF THE INVENTION

The invention is directed, in general, to integrated circuit (IC) fabrication and, more particularly, to a system and method of generating a model useful for predicting the yield of an IC fabrication process and a method of manufacturing an IC using the yield model.

### BACKGROUND OF THE INVENTION

Numerous complex and sensitive chemical and mechanical processes requiring complicated, delicate and specialized equipment are necessary to fabricate a modern IC. A modern IC fabrication facility therefore must be carefully maintained and monitored to ensure that the ICs it produces operate as intended. The effectiveness of an IC fabrication process is expressed in terms of “yield.” Yield is computed by dividing the number of properly fabricated ICs by the total number of ICs fabricated. The objective, of course, is to maximize yield.

While yield is straightforward to compute, it is difficult to predict. Yield is conventionally predicted by generating a yield model in which one or more physical characteristics, e.g., voltage, current, speed or spatial dimension, pertaining to ICs already fabricated are measured and entered into the model to predict yield.

At least four factors complicate development of a suitable yield model. First, many (perhaps hundreds of) physical characteristics of an IC (frequently referred to herein as “X-variables”) may be measured before or during IC fabrication and therefore represent potential candidates for incorporation into a yield model. Selecting the candidates that have the best chance of predicting yield involves significant statistical analysis on the part of a trained and experienced statistician. A typical conventional process involves multiple bivariate regression analyses or multiple one-way ANOVAs (Analyses of Variance).

Second, the selected “best” X-variables must be correctly incorporated into the yield model. This not only requires significant statistical analysis, but also educated intuition on the part of the statistician. A typical conventional process involves forming the most highly correlated X-variables into a regression equation that constitutes the yield model.

Third, generating a yield model requires a compromise between two disparate objectives: predictive power and simplicity (called “parsimony”). A model that incorporates many X-variables may predict yield more accurately, but tends to be much more difficult to generate, test and operate. Conversely, a parsimonious model may not be sufficiently predictive. The issue centers around the number of X-variables that should be incorporated into the yield model.

Unfortunately, the conventional process analysis often produces suboptimal results, forcing the statistician to add or delete X-variables and reform the polynomial function in an effort to improve its predictive ability. Thus, the fourth complicating factor is that a successful yield model often arises only following a protracted process of trial and error, which takes substantial time and effort.

To complicate matters further, the X-variables that best predict the yield of one fabrication process may not predict yield well with respect to another fabrication process. Thus a separate yield model is typically required for each fabrication process. This multiplies the work the statistician faces.

Still further, X-variable data gathered from multiple fabrication processes is vulnerable to the so-called “device effect,” whereby variations among the multiple processes commingle with variations within each process and thereby confuse the data. Avoiding the device effect requires data to be gathered from each process separately, which reduces the statistical power brought about by compounding data from multiple processes.

What is needed in the art is a better way to generate a yield model. More specifically, what is needed in the art are better ways of selecting the “X-variables” to be candidates for incorporation into a yield model and incorporating selected appropriate candidates to produce a reasonably parsimonious, but reasonably accurate, yield model. What is further needed in the art is a better way to manufacture ICs.

### SUMMARY OF THE INVENTION

To address the above-discussed deficiencies of the prior art, the invention provides, in one aspect, a system for generating a yield model pertaining to an IC fabrication process. In one embodiment, the system includes: (1) an X-variable selector configured to select X-variables as candidates for incorporation into the yield model, (2) a candidate sorter associated with the X-variable selector and configured to sort the candidates into an order based on a ranking criterion and (3) a candidate evaluator associated with the candidate sorter and configured to introduce the candidates in the order into a stepwise forward regression model until a marginal significance associated with a candidate to be introduced into the model falls below a threshold.

In another aspect, the invention provides a method of generating a yield model pertaining to an IC fabrication process. In one embodiment, the method includes: (1) selecting X-variables as candidates for incorporation into the yield model, (2) sorting the candidates into an order based on a ranking criterion and (3) introducing the candidates in the order into a stepwise forward regression model until a marginal significance associated with a candidate to be introduced into the model falls below a threshold.

In yet another aspect, the invention provides a method of manufacturing an IC. In one aspect, the method includes: (1) generating a yield model by selecting X-variables as candidates for incorporation into a yield model, sorting the candidates into an order based on a ranking criterion and introducing the candidates in the order into a stepwise forward regression model until a stopping point is reached and (2) evaluating process steps in an IC fabrication process based on predictions generated by the yield model.

The foregoing has outlined preferred and alternative features of the invention so that those skilled in the pertinent art may better understand the detailed description of the invention that follows. Additional features of the invention will be described hereinafter that form the subject of the claims of the invention. Those skilled in the pertinent art should appreciate that they can readily use the disclosed conception and specific embodiment as a basis for designing or modifying other structures for carrying out the same purposes of the invention. Those skilled in the pertinent art should also realize that such equivalent constructions do not depart from the scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates a flow diagram of one embodiment of one method of selecting X-variables for incorporation into a yield model carried out according to the principles of the invention;

FIG. 2 illustrates a graph displayable via a GUI and demonstrating use of Analysis of Covariance (ANCOVA) to analyze X-variables pertaining to more than one IC fabrication process;

FIG. 3 illustrates a flow diagram of one embodiment of another method of selecting X-variables for incorporation into a yield model carried out according to the principles of the invention;

FIG. 4 illustrates a graph displayable via a graphical user interface (GUI) and demonstrating use of Pearson's Contingency Test to determine whether deciles of yield are statistically independent of deciles of X-variables;

FIG. 5 illustrates a flow diagram of one embodiment of a method of generating a yield model pertaining to an IC fabrication process and manufacturing an IC carried out according to the principles of the invention;

FIG. 6 illustrates an image displayable via a GUI representing a stepwise forward regression model, a total significance of said stepwise forward regression model and said marginal significance; and

FIG. 7 illustrates a block diagram of one embodiment of a system for generating a yield model constructed according to the principles of the invention.

### DETAILED DESCRIPTION

Disclosed herein are various embodiments of systems and methods of generating a yield model. Some embodiments are specifically directed to the use of GUI tools to build a powerful multivariate yield model.

An initial phase of generating a yield model involves an X-variable selection process. Accordingly, two methods of selecting X-variables as candidates for consideration of incorporation into a yield model will first be described. The methods may be used separately or jointly, in combination with one or more other methods as may be suitable for a particular application. Alternatively, other methods may be used to the exclusion of the two methods described herein.

After candidates are selected, at least some of the candidates are incorporated into a stepwise forward linear or logistic regression analysis in a subsequent phase involving an incorporation process. As will be seen, the incorporation process disfavors dependent X-variables. Accordingly, the X-variable selection process should capture nonlinear dependencies so they can be taken into account.

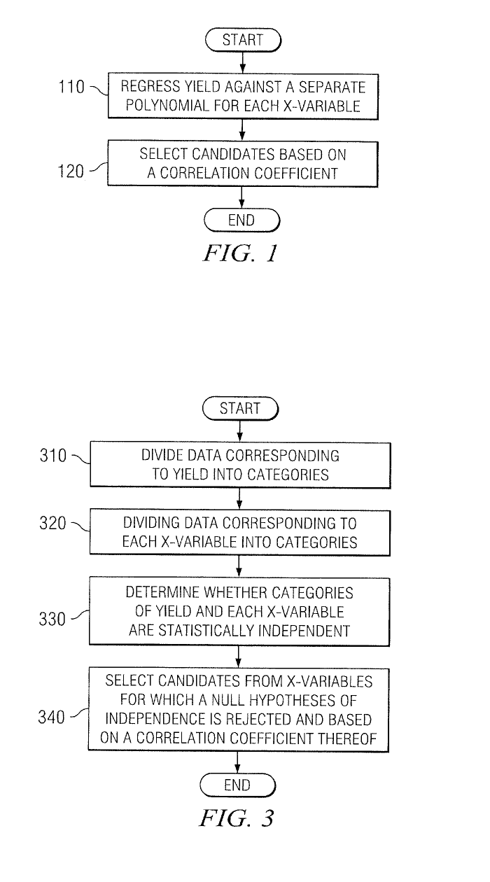

FIG. 1 illustrates a flow diagram of one embodiment of one method of selecting X-variables for incorporation into a yield model carried out according to the principles of the invention. The method begins in a start step. In a step 110, yield is regressed against separate polynomials of at least a second order corresponding to the X-variables. In one embodiment, the polynomials are of the second order.

In a step 120, the candidates are selected based a (typically the largest) correlation coefficient of the polynomial model, or based on the smallest partial p-value. In one embodiment, the correlation coefficient ranking is based upon the coefficient of determination, R². The coefficient of determination is the square of the correlation coefficient, which is Pearson's correlation coefficient, r. In another embodiment, the partial p-value comes from the F statistic when comparing the model with and without an additional candidate. Those skilled in the pertinent art understand that Pearson's correlation coefficient measures the strength and direction of a linear relationship between an X-variable and a Y-variable, which is yield in this application. (see, e.g., http://www.stat.tamu.edu/stat30x/notes/node39.html). Likewise, the partial p-value relates to the statistical significance, which is 100%*(1−p). In one embodiment, the polynomials are sorted on decreasing value of R². In another embodiment, the sorting is on ascending partial p-value. Then, the top (e.g., six to eight) candidates are selected for potential incorporation into the yield model. The invention is not, however, limited as to the number of candidates that may be selected. The method ends in an end step.

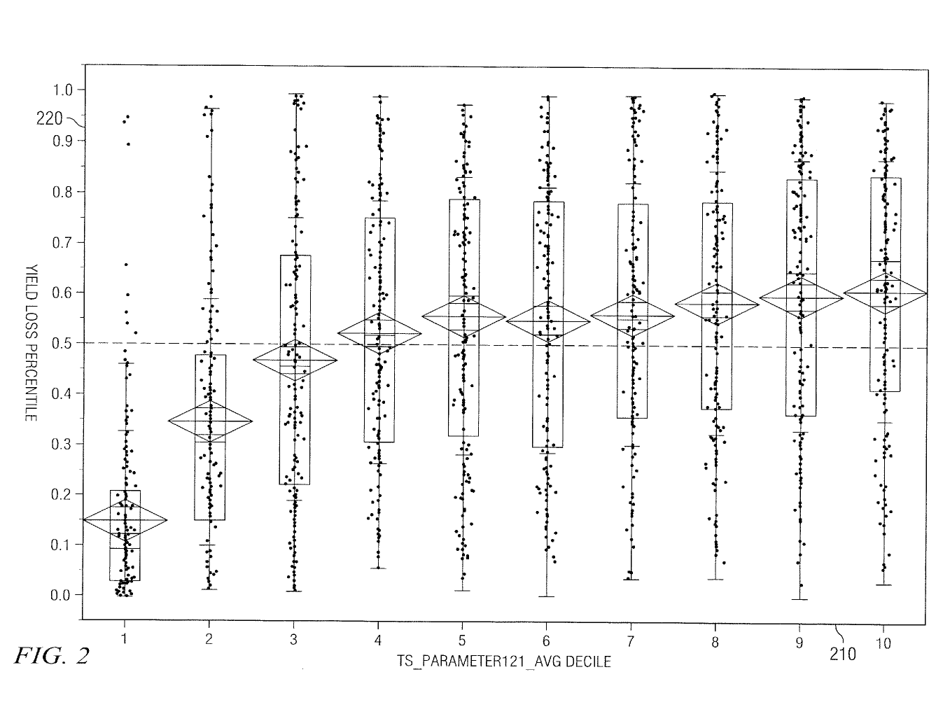

FIG. 2 illustrates a graph displayable via a GUI and demonstrating use of Analysis of Covariance (ANCOVA) to analyze X-variables pertaining to more than one IC fabrication process. In the ANCOVA method, the categorical variable indicating the device is included in the model. Alternately, rank statistics or categories may be generated for each device separately thereby to reduce any device effect. The well-known ANCOVA method may be used if the X-variable data were taken from more than one device to ensure that covariance within data pertaining to each device is separated from covariance within data pertaining to the other devices. FIG. 2 shows data pertaining to an X-variable “TS_Parameter121_AVG” divided into deciles along an X-axis 210 and yield divided into percentages along a Y-axis 220. The deciles are preferably generated for the data from each device separately, before analysis. Alternatively, yield may be converted into other estimators (e.g., “logits” or “probits”).

FIG. 3 illustrates a flow diagram of one embodiment of another method of selecting X-variables for incorporation into a yield model carried out according to the principles of the invention. The method begins in a start step. In a step 310, data corresponding to the yield are divided into categories. In one embodiment, the yield is divided into columns containing its deciles, with deciles set using the data per device. Those skilled in the pertinent art understand, however, that other categories, such as dichotomy, quartiles, heptiles, and percentiles may be used.

In a step 320, data corresponding to each of the X-variables are also divided into categories. (X-variables derived from inline tools are frequently already categorical.) In one embodiment, each X-variable is divided into columns containing its deciles. Again, those skilled in the pertinent art understand that other categories may be used.

At this point, extreme data, or “outliers,” may be removed, e.g., by using a conventional Tukey screening technique for each column to remove, e.g., the outlying few percent of data. In a step 330, it is determined whether categories of the yield are statistically independent of categories of each of the X-variables.

In a step 340, the candidates from X-variables for which a null hypotheses of independence is rejected are selected based on a correlation coefficient thereof. In one embodiment, Pearson's Contingency Test is used to determine whether deciles of yield are statistically independent of deciles of each X-variable (see, e.g., http://spider.stat.umn.edu/R/library/stats/html/chisq.test.html). In one embodiment, the top six to eight of the candidates are selected for potential incorporation into the yield model. As before, the invention is not limited as to the number of candidates that may be selected. The method ends in an end step.

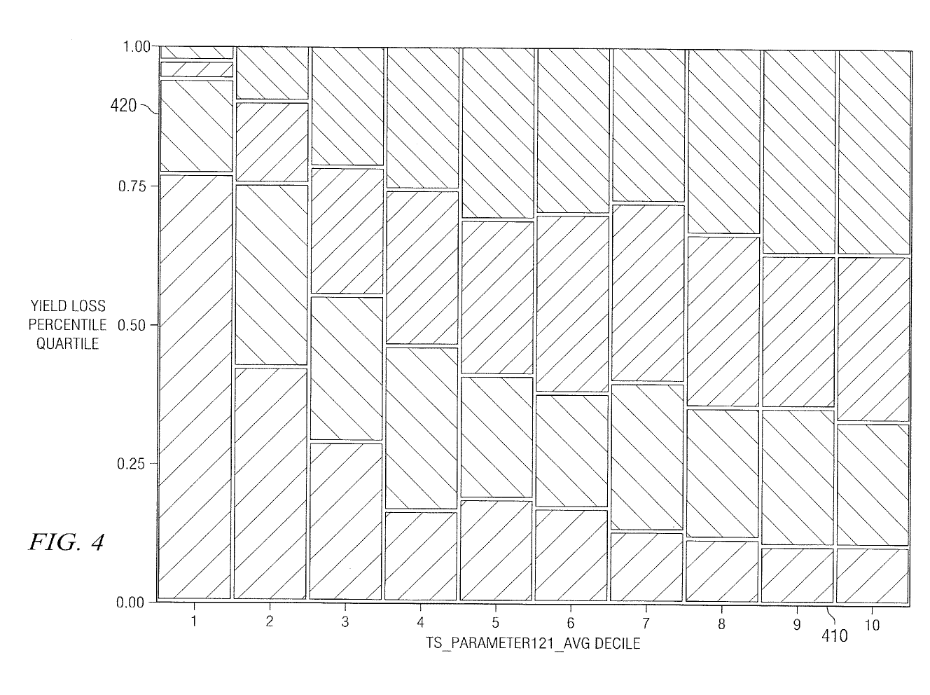

FIG. 4 illustrates a graph displayable via a graphical user interface (GUI) and demonstrating use of Pearson's Contingency Test to determine whether deciles of yield are statistically independent of deciles of X-variables. As with FIG. 2, the X-variable is TS_Parameter121_AVG, the X-axis 410 is divided into deciles and the Y-axis 420 (yield) is divided into percentages. Assuming Pearson's Contingency Test is employed, the X-variables for which the null hypotheses of independence is rejected may then be sorted on ascending p-value. As before, the top six to eight of the candidates may be selected for potential incorporation into the yield model. Software code that may be adapted to carry out at least some of the second method may be found in Rud, Data Mining Cookbook, John Wiley & Sons, New York, 2000, which is incorporated herein by reference.

If the X-variable data were taken from more than one device, yield deciles should be separately established for each device. Alternately, yields may be converted into percentiles, which converts each device's yields into separate percentiles.

Assuming for the purposes of discussion that both of the two described selection methods are used, a dozen or more candidate X-variables (and terms containing their squares corrected for the mean) may result. According to the embodiments described herein, these are incorporated into a stepwise forward regression model, more formally called a Stepwise Forward Multivariate Regression Model (SFMVM). The SFMVM is described in, e.g., Darlington, Regression and Linear Models, New York: McGraw-Hill, 1990, incorporated herein by reference.

Stepwise regression is a technique for choosing the variables, i.e., terms, to include in a multiple regression model. Stepwise forward regression starts with no model terms. At each step it adds the most statistically significant term (the one with the highest F statistic or lowest partial p-value) until a stopping point is reached. A stopping point may occur when no X-variables are left to incorporate, when a predetermined number of X-variables have been incorporated or, particularly advantageously, when a marginal significance associated with a candidate to be introduced into the model falls below a threshold (e.g., 3%), in other words, when the introduction of further candidates into the yield model fails to improve the predictive power of the yield model.

An important assumption behind SFMVM is that some input variables in a multiple regression do not have an important explanatory effect on the response. If this assumption is true, then it is a convenient simplification to keep only the statistically significant terms in the model.

One common problem in multiple regression analysis is multicolinearity of the candidate X-variables. The input variables may be as correlated with each other as they are with the response; the presence of one variable in the model may thus mask the effect of another variable. This problem is certainly encountered in generating yield models. An SFMVM is particularly advantageous in that, when an X-variable is stepwise-added into the yield model, the partial F-value associated with any other multicolinear X-variables is greatly decreased. This drastically reduces their likelihood of being the next variable entered into the yield model. SFMVM allows personnel other than trained, experienced statisticians to generate yield models, since they do not need to appreciate the underlying statistical relationships among the X-variables and yield, but only the marginal significance that incorporation of a particular X-variable has on the yield model.

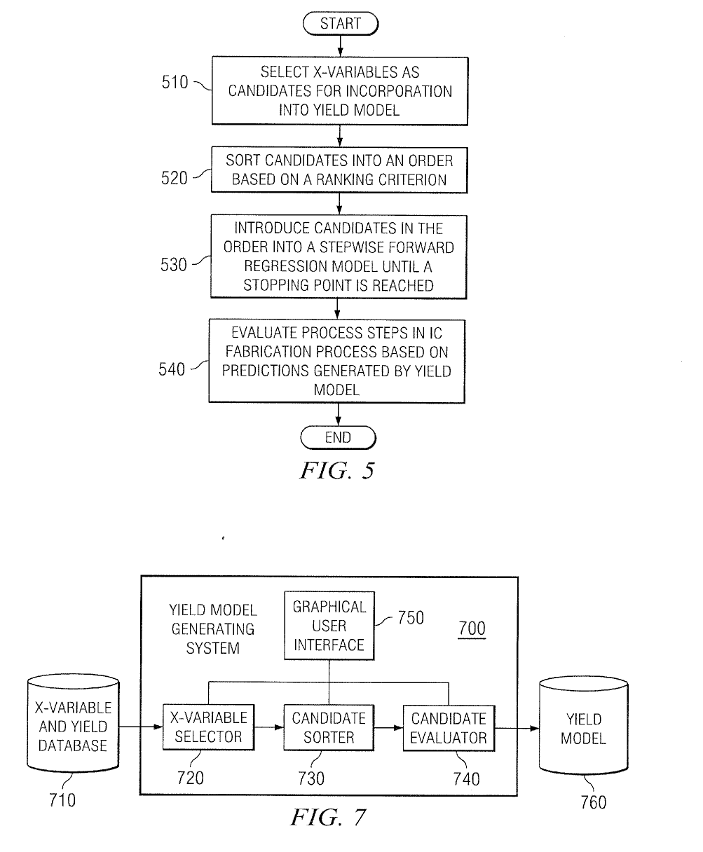

FIG. 5 illustrates a flow diagram of one embodiment of a method of generating a yield model pertaining to an IC fabrication process and manufacturing an IC carried out according to the principles of the invention. The method begins in a start step. In a step 510, X-variables are selected as candidates for incorporation into the yield model. Selection may be by one or both of the above-described methods, or by one or more other methods as may be appropriate to a particular application. In a step 520, the candidates are sorted into an order based on a ranking criterion (e.g., highest correlation coefficient or fit). In a step 530, the candidates are introduced in the order into a stepwise forward regression model until a stopping point (as described above) is reached.

If it is desired to use the yield model to manufacture an IC, a step 540 may be carried out in which process steps in an IC fabrication process are evaluated based on predictions generated by the yield model. For example, the efficacy of a gas used to fabricate ICs may be judged; the sensitivity of a process temperature, pressure or time may be determined, equipment that has been repaired, modified, replaced or added may be tested; or process steps that have been added or omitted may be evaluated. The yield of a fabrication process may therefore be substantially improved through use of a yield model generated according to the principles of the invention. The method ends in an end step.

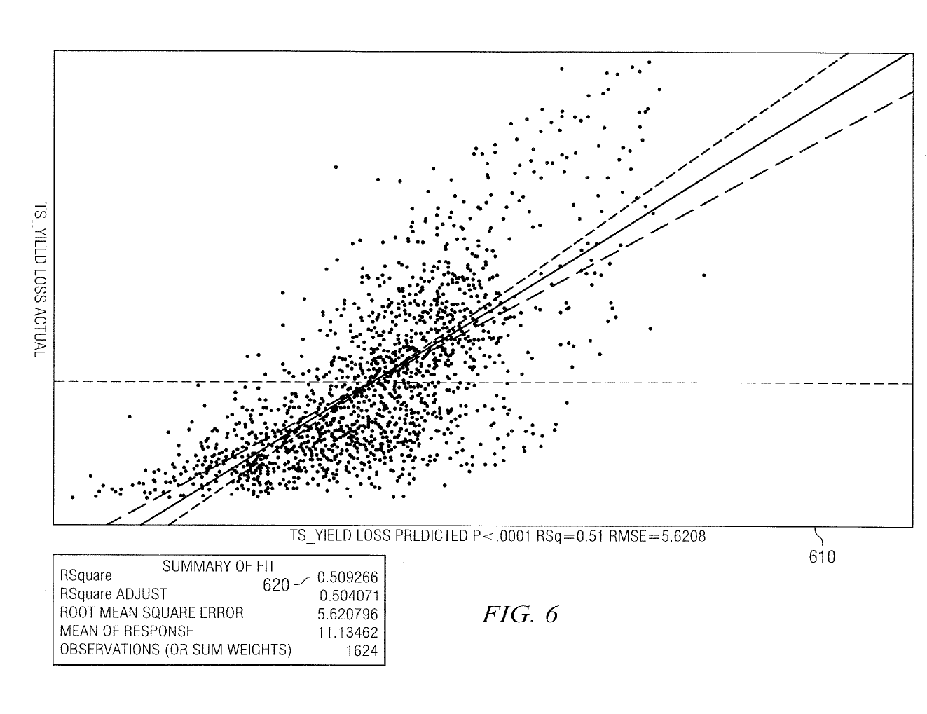

Certain embodiments of the invention employ a GUI to advantage to allow the generation of a yield model to be undertaken visually. FIG. 6 illustrates an image displayable via a GUI representing a stepwise forward regression model 610 and the coefficient of determination (R²) of the stepwise forward regression model 620.

In one embodiment, Spotfire® (commercially available from Spotfire, Inc., of Somerville, Mass.), which is a GUI, may be used to extract and merge data from one or more Oracle® databases (Oracle is commercially available from Oracle Corporation of Redwood Shores, Calif.). JMP® (commercially available from SAS Institute, Incorporated of Cary, N.C.), which is a statistical analysis GUI, provides extended statistical analysis with useful graphics. JMP® includes various other data-mining routines, giving even more variety in ways to choose candidate X-variables for multivariate modeling. JMP® allows personnel other than trained, experienced statisticians to generate yield models, since they are not required to code in SAS®.

FIG. 7 illustrates a block diagram of one embodiment of a system, generally designated 700, for generating a yield model constructed according to the principles of the invention. FIG. 7 illustrates an X-variable and yield database 710 (e.g., an Oracle database) from which data may be extracted for analysis.

The system 700 includes an X-variable selector 720. The X-variable selector 720 is configured to select X-variables as candidates for incorporation into the yield model. The system 700 further includes a candidate sorter 730 associated with the X-variable selector 720. The candidate sorter 730 is configured to sort the candidates into an order based on a ranking criterion. The system 700 further 700 includes a candidate evaluator 740 associated with the candidate sorter 730. The candidate evaluator 740 is configured to introduce the candidates in the order into a stepwise forward regression model until a marginal significance associated with a candidate to be introduced into the model falls below a threshold.

One embodiment of the system 700 further includes a GUI 750. The GUI 750 is associated with the X-variable selector 720, the candidate sorter 730 and the candidate evaluator 740. One specific embodiment of the GUI 750 is configured to display an image representing the stepwise forward regression model including an overall coefficient of determination of the stepwise forward regression model.

The system 700 generates a yield model 760, which may be used to predict yield. The yield model 760 advantageously may be parsimonious, yet accurate.

Although the invention has been described in detail, those skilled in the pertinent art should understand that they can make various changes, substitutions and alterations herein without departing from the spirit and scope of the invention in its broadest form.

What is claimed is:

1. A system for generating a yield model pertaining to an integrated circuit (IC) fabrication process, comprising:
an X-variable selector configured to select X-variables as candidates for incorporation into said yield model;
a candidate sorter associated with said X-variable selector and configured to sort said candidates into an order based on a ranking criterion; and
a candidate evaluator associated with said candidate sorter and configured to introduce said candidates in said order into a stepwise forward regression model until a stopping point is reached.

2. The system as recited in claim 1 wherein said X-variable selector is configured to regress yield against separate polynomials of at least a second order corresponding to said X-variables and select said candidates based on a selected one of largest coefficients of determination and smallest partial p-values of said polynomials.

3. The system as recited in claim 1 wherein said X-variable selector is configured to divide data corresponding to said yield into categories, divide data corresponding to each of said X-variables into categories, determine whether categories of said yield are statistically independent of categories of each of said X-variables and select said candidates from X-variables for which a null hypotheses of independence is rejected and based on a correlation coefficient thereof.

4. The system as recited in claim 1 wherein data corresponding to said X-variables pertain to more than one IC fabrication process and said X-variable selector carries out an Analysis of Covariance (ANCOVA).

5. The system as recited in claim 1 further comprising a graphical user interface (GUI) associated with said candidate evaluator and configured to display an image representing said stepwise forward regression model, a total significance of said stepwise forward regression model and said marginal significance.

6. A method of generating a yield model pertaining to an integrated circuit (IC) fabrication process, comprising:
selecting X-variables as candidates for incorporation into said yield model;
sorting said candidates into an order based on a ranking criterion; and
introducing said candidates in said order into a stepwise forward regression model until a stopping point is reached.

7. The method as recited in claim 6 wherein said selecting includes:
regressing yield against separate polynomials of at least a second order corresponding to said X-variables; and
selecting said candidates based on a selected one of largest coefficients of determination and smallest partial p-values of said polynomials.

8. The method as recited in claim 7 wherein said polynomials are of said second order.

9. The method as recited in claim 6 wherein said selecting includes:
dividing data corresponding to said yield into categories;
dividing data corresponding to each of said X-variables into categories;
determining whether categories of said yield are statistically independent of categories of each of said X-variables; and
selecting said candidates from X-variables for which a null hypotheses of independence is rejected and based on a correlation coefficient thereof.

10. The method as recited in claim 9 wherein said categories are selected from the group consisting of:
dichotomy,
quartiles,
heptiles,
deciles, and
percentiles.

11. The method as recited in claim 6 wherein data corresponding to said X-variables pertain to more than one IC fabrication process and said selecting includes carrying out an Analysis of Covariance (ANCOVA).

12. The method as recited in claim 6 wherein said ranking criterion is a partial p-value associated with a calculated F-value.

13. The method as recited in claim 6 wherein said stepwise forward regression model is selected from the group consisting of:
a stepwise forward linear regression model, and
a stepwise forward logistic regression model.

14. The method as recited in claim 6 wherein said stopping point is reached when a marginal significance associated with a candidate to be introduced into said model falls below a threshold.

15. The method as recited in claim 6 wherein said introducing includes employing a graphical user interface (GUI) to display an image representing said stepwise forward regression model, a total significance of said stepwise forward regression model and said marginal significance.

16. A method of manufacturing an integrated circuit, comprising:
generating a yield model by selecting X-variables as candidates for incorporation into a yield model, sorting said candidates into an order based on a ranking criterion and introducing said candidates in said order into a stepwise forward regression model until a stopping point is reached; and
evaluating process steps in an integrated circuit fabrication process based on predictions generated by said yield model.

17. The method as recited in claim 16 wherein said selecting includes:
regressing yield against separate polynomials of at least a second order corresponding to said X-variables; and
selecting said candidates based on a selected one of largest coefficients of determination and smallest partial p-values of said polynomials.

18. The method as recited in claim 16 wherein said selecting includes:
dividing data corresponding to said yield into categories;
dividing data corresponding to each of said X-variables into categories;
determining whether categories of said yield are statistically independent of categories of each of said X-variables; and
selecting said candidates from X-variables for which a null hypotheses of independence is rejected and based on a correlation coefficient thereof.

19. The method as recited in claim 16 wherein data corresponding to said X-variables pertain to more than one IC fabrication process and said selecting includes carrying out an Analysis of Covariance (ANCOVA).

20. The method as recited in claim 16 wherein said introducing includes employing a graphical user interface (GUI) to display an image representing said stepwise forward regression model, a total significance of said stepwise forward regression model and said marginal significance.
